(19) United States
(12) Patent Application Publication
(10) Pub. No.: US 2006/0145886 A1
(43) Pub. Date: Jul. 6, 2006

(54) Remote controller with a light source

(75) Inventor: Ching-Chang Hsu, Panchiao City (TW)

Correspondence Address: Ladas & Parry, Suite 2100, 5670 Wilshire Boulevard, Los Angeles, CA, 90036-2300, US

(73) Assignee: HANNSPREE, INC.

(21) Appl. No.: 11/028,418

(22) Filed: Dec. 30, 2004

(51) Int. Cl. G08B 5/00

(52) U.S. Cl. 340/815.4

(57) ABSTRACT

A remote controller includes a casing, a control circuit, and a light source. The casing defines a recess, and has a light transmissible shell that covers the recess. The control circuit is mounted in the recess in the casing, and includes a set of electrical contacts coupled to a power source. The light source is coupled to the control circuit, is mounted in the recess in the casing, and is automatically activated by the power source when the electrical contacts of the control circuit are connected electrically to the power source.

### BACKGROUND OF THE INVENTION

1. Field of the Invention

The invention relates to a remote controller, more particularly to a remote controller that has a light source for easily locating a misplaced remote controller.

2. Description of the Related Art

A conventional remote controller is operable so as to transmit different control signals that are to be received by an electronic device for controlling operation of the electronic device.

The conventional remote controller is disadvantageous in that it cannot be easily located when misplaced.

### SUMMARY OF THE INVENTION

Therefore, the object of the present invention is to provide a remote controller that is capable of overcoming the aforementioned drawback of the prior art.

According to the present invention, a remote controller comprises a casing, a control circuit, and a light source. The casing defines a recess, and a light transmissible shell that covers the recess. The control circuit is mounted in the casing, and includes a set of electrical contacts adapted to be coupled to a power source. The light source is coupled to the control circuit, is mounted in the recess, and is adapted to be automatically activated by the power source when the electrical contacts are connected electrically to the power source.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of the preferred embodiment of a remote controller according to the present invention; and

FIG. 2 is a schematic view of a control circuit of the preferred embodiment.

### DETAILED DESCRIPTION OF THE PREFERRED EMBODIMENT

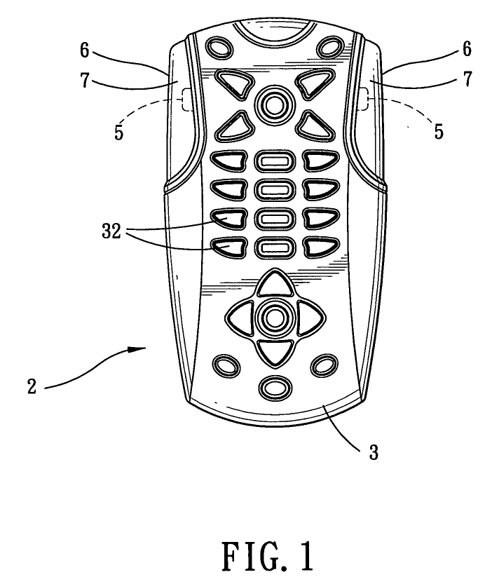

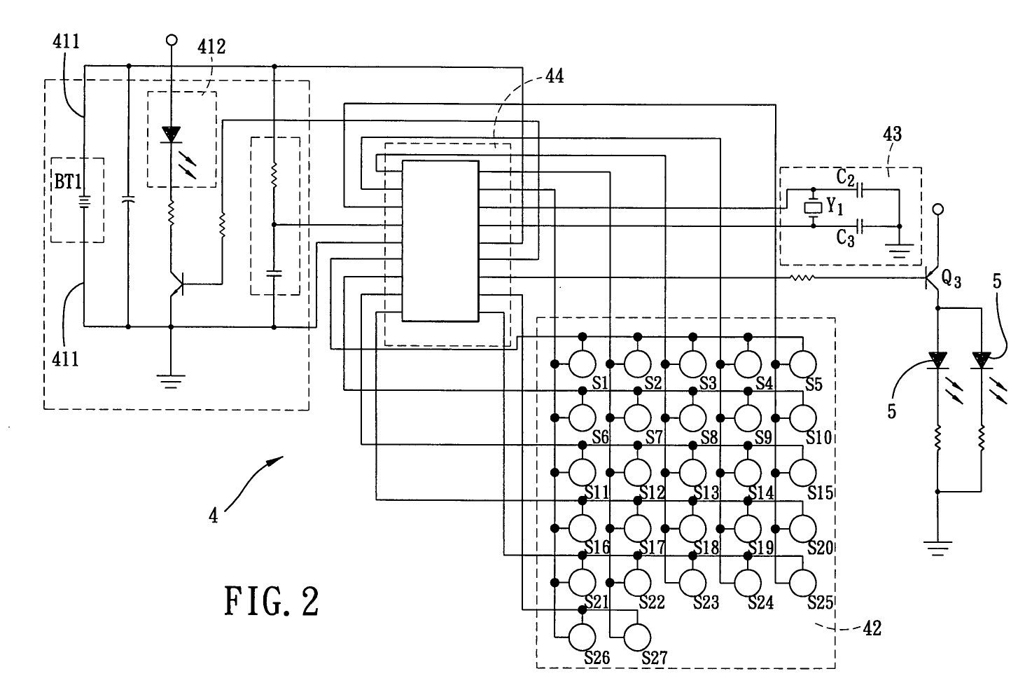

Referring to FIGS. 1 and 2, the preferred embodiment of a remote controller 2 according to this invention is shown to include a casing 3, a control circuit 4, and a pair of light sources 5.

The remote controller 2 is operable so as to transmit different control signals that are to be received by an electronic device (not shown) for controlling operation of the electronic device, in a manner well known in the art.

The casing 3 has a pair of recesses 7, each of which is disposed in one of lateral sides of an end portion of the casing 3, and a pair of light transmissible shells 6, each covers one of the recesses 7.

The control circuit 4 is mounted in the casing 3, and includes a pair of electrical contacts 411, each of which is connected electrically to a power source (BT1), such as a battery cell.

Each of the light sources 5 is coupled to the control circuit 4, and is mounted in one of the recesses 7 in the casing 3. In this embodiment, each of the light sources 5 is automatically activated by the power source (BT1) when the electrical contacts 411 of the control circuit 4 are connected to the power source (BT1). Preferably, each of the light sources 5 is a light-emitting diode.

The control circuit 4 further includes a processor 44 and a switch (Q3). The processor 44 of the control circuit 4 is coupled to the electrical contacts 411 of the control circuit 4. The switch (Q3) of the control circuit 4 is coupled to and is controlled by the processor 44 of the control circuit 4, and is coupled to the electrical contacts 411 through the processor 44 of the control circuit 4. In this embodiment, the switch (Q3) of the control circuit 4 is operable so as to make or break the electrical connection between the electrical contacts 411 of the control circuit 4 and the light sources 5. Preferably, the switch (Q3) of the control circuit 4 is a PNP transistor.

The processor 44 of the control circuit 4 automatically turns on the switch (Q3) of the control circuit 4 when the electrical contacts 411 of the control circuit 4 are connected to the power source (BT1), thereby activating each of the light sources 5 to emit a visible light through the light transmissible shell 6 of the casing 3.

In an alternative embodiment, the processor 44 of the control circuit 4 is designed to automatically turn the switch (Q3) of the control circuit 4 on and off intermittently when the electrical contacts 411 of the control circuit 4 are connected to the power source (BT1) such that each of the light sources 5 emits a visible flashing light through the light transmissible shell 6 of the casing 3.

It is noted that in an alternative embodiment, the casing 3 may be made from a light transmissible material.

The control circuit 4 further includes a timer 43 that is operable so as to provide a clock signal to the processor 44 of the control circuit 4. In this embodiment, the timer 43 includes a 3.84 MHz oscillator (Y1), and a pair of capacitors (C2, C3), each of which is coupled to the oscillator (Y1).

The control circuit 4 further includes a user input unit 42 that is mounted on and that is accessible from the outside of the casing 3, that is connected electrically to the processor 44 of the control circuit 4, and that is operable so as to enable the processor 44 of the control circuit 4 to generate the control signals. In this embodiment, the user input unit 42 includes a plurality of function keys (S1 to S27), each of which corresponds to a respective one of the control signals.

The control circuit 4 further includes a power indicator 412 that is connected electrically to the electrical contacts 411 of the control circuit 4 and that provides an indication of a battery power of the power source (BT1).

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A remote controller operable so as to transmit different control signals, said remote controller comprising:
a casing having a recess, and a light transmissible shell that covers said recess;
a control circuit mounted in said casing, and including a set of electrical contacts adapted to be coupled to a power source; and
at least a light source coupled to said control circuit, mounted in said recess, and adapted to be automatically activated by the power source when said electrical contacts are connected electrically to the power source.

2. The remote controller as in claim 1, wherein said control circuit further includes a processor, and a switch coupled to and controlled by said processor, and operable so as to make or break electrical connection between said electrical contacts and said light source,
wherein when said electrical contacts are connected to the power source, said processor automatically turns on said switch, thereby activating said light source.

3. The remote controller as in claim 1, wherein said casing has a lateral side, said recess being formed in said lateral side of said casing.

4. The remoter controller as in claim 1, wherein said light source is a light-emitting diode.
